(19) United States
(12) Patent Application Publication
(10) Pub. No.: US 2003/0065809 A1
(43) Pub. Date: Apr. 3, 2003

(54) Scheduling downstream transmissions

(75) Inventor: Daniel Byron, Marlborough, MA (US)

Correspondence Address: Fogg, Slifer & Polglaza, P.A., P.O. Box 581009, Minneapolis, MN, 55458-1009, US

(73) Assignee: ADC Telecommunications, Inc.

(21) Appl. No.: 09/970,334

(22) Filed: Oct. 3, 2001

(51) Int. Cl. G06F 15/16

(52) U.S. Cl. 709/232

(57) ABSTRACT

A method for scheduling downstream transmissions in a cable modem termination system is provided. The method includes selecting a queue based on its priority level and a state of the queue. When the selected queue has data, the method schedules transmission of a packet of data for the selected queue. When a packet is scheduled for the selected queue, the method determines whether higher priority queues have data before scheduling additional transmissions.

### TECHNICAL FIELD

The present invention relates generally to the field of telecommunications and, in particular, to scheduling downstream transmissions in a communication system.

### BACKGROUND

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable or hybrid fiber/coax network.

A cable modem termination system (CMTS) is included in the head end of the cable network for processing the upstream and downstream transmission of data. In the upstream, the CMTS converts data signals from cable modems to base band or a low intermediate frequency. The CMTS then demodulates the signals and provides the data to a network, e.g., the Internet. In the downstream, the CMTS receives data for a plurality of modems at a network interface. The CMTS modulates a carrier with this data and transmits it downstream over a shared medium, e.g., a cable or HFC network, to the plurality of modems.

One problem with the design of current CMTS equipment is that it treats all downstream data equally. That is, the CMTS does not give priority to data for any particular subscriber. This aspect of current CMTS equipment prevents service providers from offering premium service, at premium prices because there is no way to guarantee higher transmission rates for selected customers. It also hampers the service provider from being able to offer time critical services, e.g., telephony, over the cable network.

For the reasons stated above, and for other reasons stated below which will become apparent to those skilled in the art upon reading and understanding the present specification, there is a need in the art for a mechanism for scheduling transmissions in the downstream of a cable modem termination system that allows data for selected users to be given priority.

### SUMMARY

The above mentioned problems with down stream transmissions from cable modem termination systems and other problems are addressed by embodiments of the present invention and will be understood by reading and studying the following specification. Specifically, embodiments of the present invention schedule downstream transmissions in a cable modem termination system based on relative priority levels of various data flows.

In one embodiment, the transmission scheduler in a cable modem termination system (CMTS) assures that data in a high priority queue is given preferential treatment over data in a lower priority queue even if it is received after the transmission scheduler has moved on to process data in lower priority queues. The transmission scheduler accomplishes this by checking for late arriving data beginning in the highest priority queues after traffic is scheduled for data in a queue at any level of priority. This assures that data in a higher priority queue is scheduled for transmission before data in lower priority queues independent of when the data is received in the higher priority queue.

In one embodiment, the transmission scheduler prevents queues from being starved for bandwidth by higher priority queues that experience high data throughput during any given period of time. The transmission scheduler monitors the volume of data scheduled for each queue and removes a queue from consideration for scheduling traffic for a specific transmission window when data queued for the queue reaches a selected threshold level. This prevents high priority queues from using all of the bandwidth and thereby starving out the lower priority queues.

Embodiments of the traffic scheduler also increase the efficiency of the use of the downstream bandwidth. Essentially, when one or more queues are idle, the traffic scheduler reapportions the bandwidth among the active queues in proportion to an assigned percentage of the overall bandwidth available. In one embodiment, this is accomplished by shortening a window in which traffic is scheduled by an amount equal to the portion of the bandwidth associated with the idle queues.

In one embodiment, a method for scheduling downstream transmissions in a cable modem termination system is provided. The method includes selecting a queue based on its priority level and a state of the queue. When the selected queue has data, the method schedules transmission of a packet of data for the selected queue. When a packet is scheduled for the selected queue, the method determines whether higher priority queues have data before scheduling additional transmissions.

### BRIEF DESCRIPTION OF THE DRAWINGS

FIG. 1 is a block diagram of one embodiment of a communication network according to the teachings of the present invention.

FIG. 2 is a block diagram of one embodiment of a downstream scheduler for a communication network according to the teachings of the present invention.

FIGS. 3, 4, and 5 are graphs that depict examples of scheduling of transmissions according to the teachings of the present invention.

FIG. 6 is a flow chart of one embodiment of a policing process according to the teachings of the present invention.

FIG. 7 is a flow chart of one embodiment of a process for scheduling traffic according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention address problems with sharing a data path among a plurality of different flows. Embodiments of the present invention provide a traffic scheduler for downstream transmission that allows a service provider to differentiate the priority given to the various flows. Advantageously, this allows the service provider to guarantee and provide different quality of service (QoS) levels to users and to charge the subscribers for the quality of service level provided.

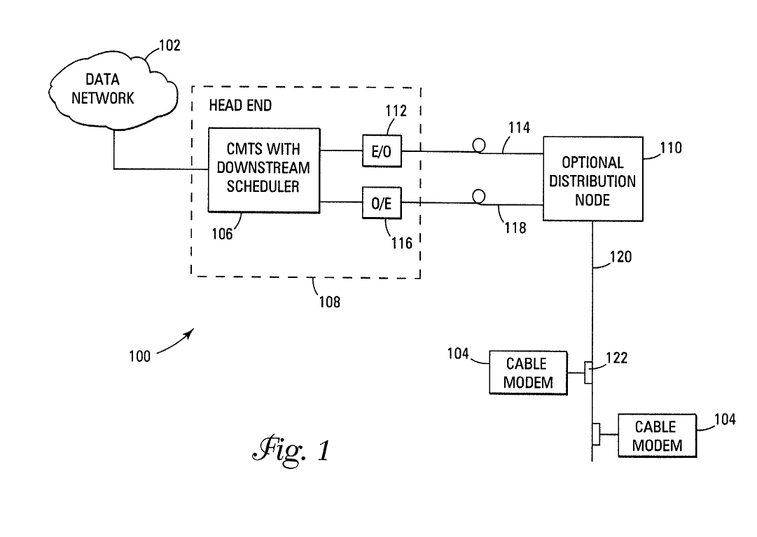

FIG. 1 is a block diagram of one embodiment of a communication network, indicated generally at 100, according to the teachings of the present invention. Advantageously, network 100 provides for the priority handling of data transmitted downstream from data network 102 to a plurality of cable modems 104 through cable modem termination system (CMTS) 106 of head end 108. CMTS 106 includes a port that is adapted to be coupled to data network 102. Further, CMTS 106 includes downstream and upstream ports. The downstream port is coupled to optical distribution node 110 through electrical to optical (E/O) converter 112 and optical cable 114. Further, the upstream port is coupled to optical distribution node 110 through optical to electrical converter (O/E) 116 and optical cable 118. Optical distribution node 110 is coupled to a plurality of cable modems 104 through one or more coaxial cables 120 and taps 122.

CMTS 106 schedules downstream transmissions in a manner that solves at least three problems with handling data on a priority basis. First, the downstream scheduler of CMTS 106 accounts for late arriving data in high priority queues. Further, the downstream scheduler of CMTS 106 prevents lower priority queues from being completely starved out by higher priority queues. Finally, the downstream scheduler also allocates the downstream bandwidth proportionately among active queues even when some queues are idle thus avoiding wasting of bandwidth. Each of these aspects of CMTS 106 is described in turn below.

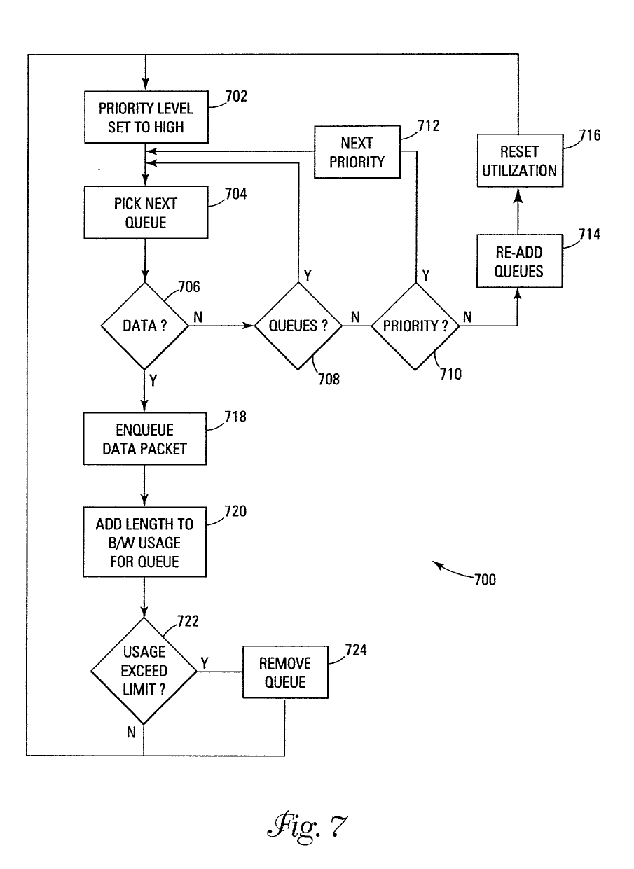

CMTS 106 schedules transmission of data received in a queue based on the priority level of the queue independent of when the data is received in the queue. This means that even if all data in a first, higher priority, queue has been scheduled for transmission and the CMTS 106 moves on to another, lower priority queue, data that arrives in the higher priority queue will be given priority in scheduling transmission over data in lower priority queues. In one embodiment, this is accomplished by checking higher priority queues for any late arriving data after scheduling any data for transmission for any priority queue. One embodiment of a process for assuring the priority handling of late arriving high priority data is described below with respect to FIG. 7.

CMTS 106 also prevents low priority queues from being starved out by higher priority queues that experience high volumes of data transmission. In one embodiment, CMTS 106 schedules transmissions for the queues over a selected time period. As transmissions are scheduled, the scheduler monitors the amount of bandwidth used by each queue. When a queue reaches a selected threshold, set based on the priority and bandwidth requirements of the queue, the queue is removed from consideration for scheduling any subsequent transmissions until a later time window. One embodiment of this aspect of CMTS 106 is also described with respect to FIG. 7.

CMTS 106 also shares the bandwidth among the active queues in proportion to their allocated bandwidth thereby avoiding wasting bandwidth in the downstream data path. In one embodiment, CMTS 106 allocates limits each queue to a selected percentage of the bandwidth in a time window. If a queue is not active, then the time window is effectively reduced by the amount of time dedicated to the inactive or idle queues. Thus, the bandwidth is effectively shared by the active queues in proportion to their respective share of the overall bandwidth.

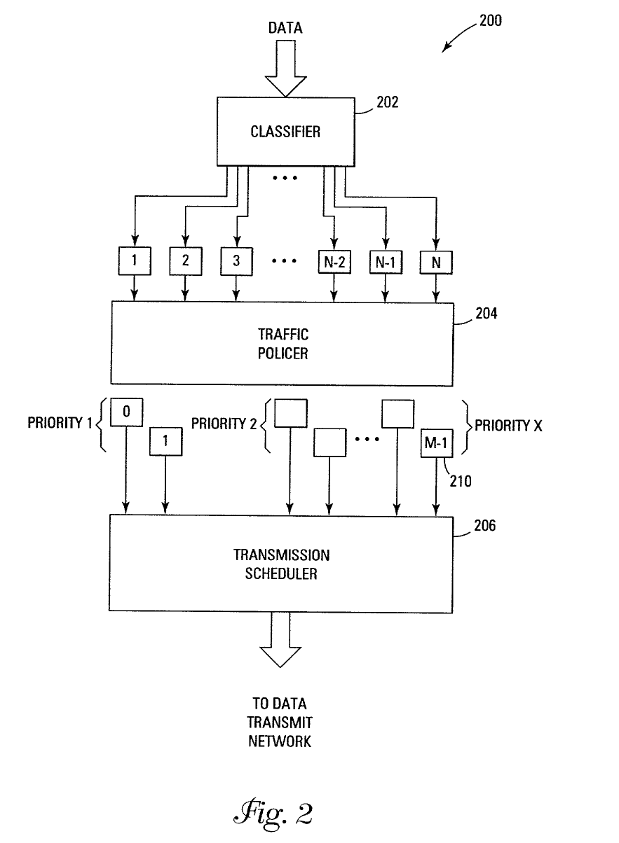

FIG. 2 is a block diagram of an embodiment of a downstream scheduler, indicated generally at 200, according to the teachings of the present invention. Downstream scheduler 200, in one embodiment, is implemented in CMTS 106 of FIG. 1. Downstream scheduler 200 includes three main functional blocks that perform aspects of the scheduling of downstream transmissions for data to be transmitted over a shared medium to a plurality of modems. These functional blocks include classifier 202, traffic policer 204 and transmission scheduler 206. Each of these functional blocks, in one embodiment, is implemented in software code in a cable modem termination system such as CMTS 106 of FIG. 1. Each of these functional blocks is described in turn below.

Classifier 202 provides the initial processing of data received for downstream transmission. Classifier 202 essentially examines the data as it is received, typically data packets, and determines which of flows 1 to N the packet belongs. Classifier 202 further marks the packer as belonging to a particular one of flows 1 to N. With this classification, the packet inherits a number of properties; namely, rate control and a class with an associated priority level.

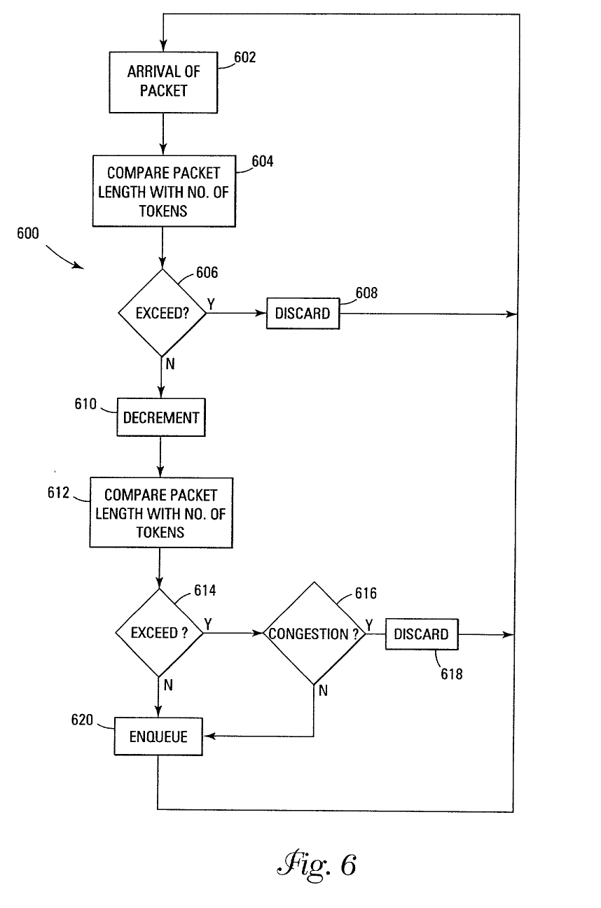

Traffic policer 204 performs additional processing of packets assigned to flows 1 to N. In one embodiment, traffic policer 204 implements the method described below with respect to FIG. 6. In one embodiment, traffic policer 204 monitors each flow for compliance with a maximum and minimum burst rate. In one embodiment, traffic policer 204 accomplishes this policing of rates using “token buckets.” A first token bucket is used to police the maximum burst rate and a second token bucket is used to police the minimum burst rate.

As a packet is processed by traffic policer 204, it is first compared against the current maximum token bucket to determine if the burst rate exceeds the specified maximum burst rate. If so, the packet is discarded. If the packet fits within the maximum burst rate, it is further compared with the minimum burst rate token bucket. Packets that fall below the minimum burst rate are marked as being below the minimum burst rate. This information is used in scheduling transmissions when a class or priority level approaches congestion.

Traffic policer 204 places non-discarded packets in an appropriate one of queues 210 to be scheduled for transmission by transmission scheduler 206. In one embodiment, downstream scheduler 200 supports 32 queues with 8 levels of priority. In other embodiments, downstream scheduler supports any appropriate number of queues with any appropriate number of priority levels. Each queue also has a maximum length, a threshold value that marks an arbitrary congestion point, and bandwidth usage information. All of the queues are kept as simple linked lists with both a head and tail pointer. Traffic policer 204 enqueues packets to the tail pointer up to the length of the queue. The length of the queue is maintained as the number of bytes contained by the enqueued packets. The threshold is an arbitrary value, less than the maximum queue length, that is defined as an indication that the queue is becoming congested. When there is congestion, the only packets that are enqueued are packets that meet the minimum burst rate requirement.

Transmission scheduler 206 processes data in queues 210 for transmission over a shared medium. Transmission scheduler 206 uses several properties of the queues in scheduling transmissions. Specifically, transmission scheduler 206 uses the queue's priority level, the queue's ‘weight’ or assigned portion of bandwidth and the queue's backlog. Regarding a queue's priority level, transmission scheduler 206 essentially processes packets in order of the queues' priorities. One embodiment of scheduling transmissions based on priority levels is described below with respect to FIG. 7.

Transmission scheduler 206 limits the bandwidth of data associated with each queue to prevent low priority queues from being starved for bandwidth by higher priority queues. Transmission scheduler 206 uses these same bandwidth limitations to reallocate bandwidth from idle queues to active queues.

Consider first that there are M queue's numbered i from 0 to M−1. Each queue (Qᵢ) is allocated a percentage of the available bandwidth, pᵢ, such that:

$$0 \leq {p}_{i} \leq 1 , a n d {\sum }_{i = 0}^{M - 1} {p}_{i} = 1 \qquad ( 1 )$$

and if Bₘₐₓ represents the maximum number of bits that can be transmitted in a time interval, T, each queue is assigned a bandwidth according to equation (2).

Bᵢ=pᵢ*Bₘₐₓ (2)

There are two cases to consider:

When the downstream link is being fully utilized; that is, Qᵢ has a length ≧Bᵢ, for all i over an interval of time, T.

When the downstream link is under utilized; that is, there is at least one Qᵢ with length <Bᵢ over an interval of time, T.

Further, for simplicity, assume that all packets are infinitely divisible. In the case of a fully utilized link, choose an interval of time, T, equivalent to the time it takes to transmit one bit. Then each Qᵢ is allowed to transmit pi percentage of a bit during that time period. Since, for the moment, all packets are infinitely divisible and the link is being fully utilized, it should be apparent that this method scales for any given T. So over any interval (t, t+T), where Qᵢ transmits Bᵢ bits, it can be seen that:

$$\frac{{B}_{i}}{{\sum }_{j = 0}^{M - 1} {B}_{j}} = {p}_{i} \qquad ( 3 )$$

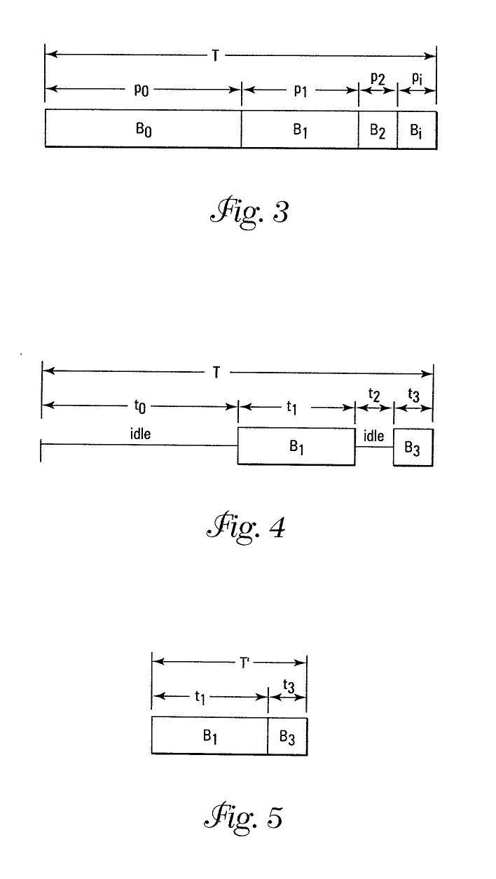

This very simple algorithm gives a perfect fit to the pᵢ's assigned. So, in this example, every T seconds the pattern of output data shown in FIG. 3 would be observed on the downstream link.

Before removing the packet divisibility restriction, consider the case of an under utilized link. In the case where a link is under utilized, it is desirable to redistribute the unused bandwidth in such a manner that each queue gets a share proportionate to it's original pᵢ. If ‘A’ is the set of all Qᵢ with length ≧1 (the active queue set):

$$\frac{{p}_{i}}{{\sum }_{j ∈ A} p j} = {p}_{i}^{′} , w h e r e {p}_{i} ∈ A \qquad ( 4 )$$

Equation (4) represents that each queue is given a new percentage of the link based on the ratio of its old percentage to the sum of the percentages of all active queues.

In the fully utilized case, the very simple algorithm is restarted every T seconds. If a particular Qᵢ was empty then that portion of the downstream link went idle and would be wasted. This is obviously an ineffective use of the downstream bandwidth. While it would be possible to recompute the pᵢs for each Qᵢ on each pass through the queues, this would require a divide operation. That would make the algorithm complex and slow. It would also be possible to precompute all the possible combinations, but with support for 32 queues, this would be a table of 2³² possible entries.

Transmission scheduler 206 implements a much simpler approach. Essentially, to increase the available percentage for each active queue, equation (3), transmission scheduler 206 shortens the time interval, T, by tᵢ, where tᵢ is the amount of time inactive queue Qᵢ would normally spend transmitting data. So if instead of waiting for T seconds to pass on each round, the algorithm accelerates the clock and simply restarts any time it finds: a) it has fully satisfied all active queues and b) it has detected idle queue's, then the available bandwidth will be distributed appropriately (that is, according to the original proportions).

FIGS. 4 and 5 illustrate an example of one embodiment of a process for transmission scheduler 206 to increase the available percentage for each active queue in proportion to their original allocation. In this example, there are four queues with the following bandwidth allocations: p₀=0.5, p₁=0.3, p₂=0.1, pᵢ=0.1. As illustrated in FIG. 4, queues Q₀ and Q₂ are idle. With queues Q₀ and Q₂ idle, transmission scheduler 206 shortens the time window from T to T′ as shown in FIG. 5 with T′ equal to the sum of the time periods in which only the active queues are transmitting.

Additionally, if instead of measuring an interval time, T, the number of bits (or bytes) is measured instead, then it is possible to use essentially the same end condition for both a fully utilized and under utilized network. Namely, each queue transmits up to its allowable bandwidth (Bi) on each pass through the queues. If a queue is empty, it is skipped. When all queues have been scanned and met their maximum bandwidth utilization, transmission scheduler restarts the algorithm. In this case:

Bᵢ=pᵢ*Bₘₐₓ (5)

where Bₘₐₓ is the maximum available downstream bandwidth.

The algorithm makes some explicit assumptions about time and bit transmission so that it can deftly change from the “time domain” to the “bit domain”. These assumptions are:

(a) The time it takes a CMTS to transmit a single bit of data is substantially constant.

(b) On average, packets will take the same amount of time to transmit, independent of packet size.

Assumption (b) is not as strong as assumption (a) and is accounted for by associating each queue with a byte count for bandwidth (as opposed to a packet count) and also maintaining a “credit” from pass to pass, as described in more detail below.

Since packets are not infinitely divisible, and packets are not all the same size, downstream scheduler 200 operates on packet boundaries. Since there is only a small probability that the total number of bytes being sent during any given interval will be exactly equal to the bandwidth allotted that queue during a given interval, a rule for handling packets that run over the allotted bandwidth is enforced.

During each pass through the queue's, the number of bytes sent by each queue is accumulated (Sᵢ). When a given queue's byte count exceeds it's allocated limit (Sᵢ≧Bᵢ), the queue will be marked as over-limit for the remainder of that pass and will not be allowed to transmit anymore. The byte accumulations are reset with each pass (Sᵢ=0). When deciding whether a packet of length l can be transmitted or not, the algorithm looks to see if at least half of the packet would be within the allotted limit, Bᵢ, as represented by equation (6).

(Bᵢ−Sᵢ)≧(½) (6)

If so, then the packet is transmitted, the queue is marked as over-limit and the accumulation for that queue, Sᵢ, is incremented by l. If not, then the packet is deferred until the next pass. The queue is still marked as over-limit even though it technically has not reached that point. This will avoid wasting time revisiting the queue multiple times for work that can't be performed. To avoid over scheduling the downstream, a queue that goes over it's allotment will have that amount deducted from it's allotment on the next pass (instead of Sᵢ=0, Sᵢ=Sᵢ−Bᵢ). Likewise any queue that had to defer sending a packet because of this condition should be credited the difference (instead of Sᵢ=0, Sᵢ=Bᵢ−Sᵢ).

In one embodiment, allotment credit is only given in the case where a queue was prevented from transmitting because of a potential overflow condition. Idle queues do not accumulate allotments until they are ready to transmit. Any bandwidth that is passed up by an idle queue is gone.

Transmission scheduler 206 also handles scheduling of “late-arriving” packets with the appropriate priority. Within a given scheduling pass, queues are scanned in priority order starting from highest and proceeding to lowest. A bit mask is maintained for each priority level that contains a bit for each queue operating with that priority. Within a priority band, queues are serviced round robin.

In order to meet the “late arrival” requirement, the scanning of the queues restart after any queue has transmitted a packet. This allows a higher priority, under utilized queue to continue to send data even though all or some of the intermediate queues may have reached their limit. The scheduling pass does not restart until all queues have transmitted their allotted number of bytes.

In implementing transmission scheduler 206, one issue for consideration of the network administrator is the choice of an appropriate time interval, T. This time interval is important as it controls how often the approximation of pᵢ is revised. If the time interval is too short, there is a possibility of starving out some queues. If the time interval is too long, then the pᵢ approximations may be off considerably. While the actual choice is up to the network administrator, it is possible to place a lower bound to avoid starvation.

At a minimum, the time interval must be large enough to allow the maximum packet size to be transmitted on the queue with the smallest non-zero pᵢ. A pᵢ of zero (0) is allowed and supported, but intrinsically means “best-effort”, so there is no service quality to guarantee in such a case.

As an example, consider Bₘₐₓ=40,000,000 bits per second and pₘᵢₙ=0.1 (10%) with a maximal frame size of 1518 bytes:

T=(MaxFrameInBits)/(Bₘₐₓ*pₘᵢₙ)=(1518*8)/(40,000,000*0.1)≈3 milliseconds

or

Bₘᵢₙ=Bₘₐₓ*pₘᵢₙ=(40,000,000*0.1)=4,000,000 bits/second

With a time interval of 3 milliseconds, the approximations of pᵢ are updated approximately 329 times per second. As other examples consider the following:

pₘᵢₙ=0.01 (1%) [symbol] T=30 milliseconds or 33 passes/second

pₘᵢₙ=0.005 (0.5%) [symbol] T=60 milliseconds or 16 passes/second

pₘᵢₙ=0.003 (0.3%) [symbol] T=100 milliseconds or 10 passes/second

pₘᵢₙ=0.0003 (0.03%) [symbol] T=1 second or 1 pass/second

The point to all these numbers is to show that even under extreme circumstances, the algorithm will still make a reasonable number of adjustments per second. The pₘᵢₙ=0.3% bandwidth represents a queue with only 120,000 bits per second. While 10 adjustments per second might appear low, this means that 99.7% of the rest of the bandwidth is being used for the other queues; so it would be difficult to not meet the approximations within some reasonable values.

FIG. 6 is a flow chart of one embodiment of a policing method, indicated generally and 600, according to the teachings of the present invention. In one embodiment, method 600 is implemented by traffic policer 204 of FIG. 2. Method 600 monitors a flow of data for compliance with both maximum and minimum burst rates.

Method 600 begins at block 602 with the arrival of a data packet. At block 604, method 600 begins the process of determining whether the traffic flow associated with the arriving packet is in compliance with the maximum burst rate. Method 600 accomplishes this using a token bucket algorithm. At block 604, method 600 compares the length of the data packet with a number of tokens for the maximum burst rate token bucket. At block 606, method 600 determines whether the packet length exceeds the number of tokens in the maximum burst rate token bucket. If so, the method proceeds to block 608 and discards the packet since the flow has exceeded its maximum burst rate. If, however, the flow has not exceeded its maximum burst rate, the method proceeds to block 610 and decrements the number of tokens in the token bucket for the maximum burst rate.

At block 612, method 600 further uses a minimum burst token bucket to determine compliance with a minimum burst level for the flow. At block 612, method 600 compares the packet length with the number of tokens in the minimum burst token bucket. At block 614, method 600 determines whether the packet length exceeds the number of tokens in the minimum burst token bucket. If so, the method proceeds to block 616. At 616, method 600 determines whether congestion exists in network. If so, the method proceeds to block 618 and discards the packet. If, however, method 600 determines that there is no congestion at block 616, the method proceeds to block 620 and queues the data packet. Further, if a method determines that the packet length did not exceed the number of tokens in the minimum burst token bucket, the method also proceeds to block 620 and queues the data packet.

FIG. 7 is a flow chart of one embodiment of a method, indicated generally at 700, for scheduling traffic according to the teachings of the present invention. Advantageously, method 700 assures that data received for a high priority queue is given preferential treatment over lower priority queues even if it is received after the method has moved on to process data in lower priority queues.

Method 700 begins at block 702 and begins to select a queue for scheduling transmissions based on a priority level and a state of the queue. At block 702, method 700 sets a priority level to the highest priority level and selects a queue at block 704. At block 706, method 700 determines whether there is any data in the selected queue. If there is data, the method proceeds to schedule transmission of the data as described in detail below. If, however, there is no data in the selected queue, the method proceeds to block 708. At block 708, method 700 determines whether there are additional queues in the same priority level. If there are additional queues, method 700 returns to block 704 and selects the next queue. If, however, there are no additional queues at the selected priority level, method 700 proceeds to block 710. At block 710, the method determines whether there are additional priority levels that have not yet been processed. If so, the method proceeds to block 712 and selects the next priority level and returns to block 704. If, however, all priority levels have been processed, the method proceeds to block 714 and reintroduces any queues removed from consideration and resets values used to track utilization of bandwidth by each queue at block 716. Method 700 further returns to block 702 to begin the process of scheduling transmissions for an additional time period.

When a selected queue has data as determined at block 706, method 700 schedules the data for transmission. Further, method 700 also advantageously restarts at the highest priority level after each scheduled transmission to account for any late arriving data in a higher priority queue. Further, method 700 also implements a mechanism for preventing lower priority queues from being starved out by high priority queues.

From block 706, method 700 proceeds to block 718 when a selected queue has data for transmission. At block 718, method 700 enqueues the data packet for transmission. Blocks 720, 722 and 724 implement the mechanism for preventing lower priority queues from being starved out by high priority queues. Specifically, at block 720, the length of the packet enqueued at block 718 is added to a bandwidth usage for the selected queue. At block 722, method 700 compares the bandwidth usage for the selected queue with a stored limit. If the bandwidth usage exceeds the limit, method 700 proceeds to block 724 and removes the queue from further consideration for scheduling transmissions. If however, the usage does not exceed the limit, the method proceeds to block 702. Advantageously, by returning to block 702 after scheduling the transmission of each packet, method 700 assures that late arriving packets for high priority queues are provided with high priority handling provided the high priority queue has not exceeded its bandwidth usage limit.

Although specific embodiments have been illustrated and described herein, it will be appreciated by those of ordinary skill in the art that any arrangement, which is calculated to achieve the same purpose, may be substituted for the specific embodiments shown. For example, in other embodiments, other appropriate techniques are used to monitor compliance with maximum and minimum burst rates. Further, the transmission scheduler described herein can be used in other contexts in which a plurality of queues share access to a common medium. This application is intended to cover any adaptations or variations of the present invention. Therefore, it is intended that this invention be limited only by the claims and the equivalents thereof.

What is claimed is:

1. A method for scheduling downstream transmissions in a cable modem termination system, the method comprising:
selecting a queue based on its priority level and a state of the queue;
when the selected queue has data, scheduling transmission of a packet of data for the selected queue; and
when a packet is scheduled for the selected queue, determining whether higher priority queues have data before scheduling additional transmissions.

2. The method of claim 1, wherein selecting a queue comprises:
selecting a queue with the highest priority level;
determining whether there is data in the selected queue;
when there is no data in the selected queue, moving to another queue; and
when there are no additional queues at the priority level, moving to the next priority level.

3. The method of claim 1, and further comprising:
when a packet of data is scheduled for the selected queue, determining whether a usage limit has been exceeded for the selected queue;
when the usage limit is exceeded, removing the selected queue from further consideration for scheduling transmissions.

4. The method of claim 1, wherein determining whether higher priority queues have data comprises:
returning to the highest priority level; and
checking active queues at each priority level until reaching a queue with data.

5. A method for scheduling transmission of downstream data in a cable modem termination system, the method comprising:
allocating a selected percentage of bandwidth for use by each of a plurality of queues;
when a queue is idle, sharing the bandwidth among active queues in a ratio proportionate with the percentage of bandwidth assigned to each of the plurality of queues.

6. The method of claim 5, wherein allocating a selected percentage of bandwidth comprises allocating a minimum percentage of the bandwidth for each queue.

7. The method of claim 5, wherein sharing the bandwidth among active queues comprises shortening a time interval for transmission when active queues have met their respective bandwidth limit and at least one queue is idle.

8. A method for scheduling transmission of downstream data in a cable modem termination system, the method comprising:
scheduling transmission of packets of data in a plurality of prioritized queues in order of proirity; and
limiting each queue to a maximum amount of data in a time interval to allow low priority queues to transmit data.

9. The method of claim 8, and further comprising checking for data in higher priority queues upon scheduling transmission of a packet.

10. The method of claim 8, wherein limiting each queue comprises removing the queue from consideration for scheduling transmissions when a threshold is exceeded.

11. A method for controlling access to a shared medium, the method comprising:
classifying packets received into a plurality of flows;
policing each flow for compliance with selected data rates;
storing data for each flow in one of a plurality of queues at a selected priority level; and
scheduling transmissions from the plurality of queues, including:
selecting a queue based on its priority level and a state of the queue,
when the selected queue has data, scheduling transmission of a packet of data for the selected queue, and
when a packet is scheduled for the selected queue, determining whether higher priority queues have data before scheduling additional transmissions.

12. The method of claim 11, wherein selecting a queue comprises:
selecting a queue with the highest priority level;
determining whether there is data in the selected queue;
when there is no data in the selected queue, moving to another queue; and
when there are no additional queues at the priority level, moving to the next priority level.

13. The method of claim 11, and further comprising:
when a packet of data is scheduled for the selected queue, determining whether a usage limit has been exceeded for the selected queue;
when the usage limit is exceeded, removing the selected queue from further consideration for scheduling transmissions.

14. The method of claim 11, wherein determining whether higher priority queues have data comprises:
returning to the highest priority level; and
checking active queues at each priority level until reaching a queue with data.

15. A method for scheduling transmission of downstream data in a cable modem termination system, the method comprising:
scheduling transmission of packets of data in a plurality of prioritized queues in order of priority; and
checking for data in high priority queues each time a packet of data is scheduled for transmission.

16. A method for scheduling downstream transmissions in a cable modem termination system, the method comprising:
selecting a highest priority level;
selecting a queue in the highest priority level;
determining whether there is data in the selected queue;
when there is no data in the selected queue, moving to the next queue;
when there are no additional queues at the priority level, moving to the next priority level;
when there is data in a selected queue, scheduling transmission of a packet of data;
when a packet is scheduled, determining whether a usage limit has been exceeded;
when the usage limit is exceeded, removing the queue from further consideration for scheduling transmissions; and
when a packet is scheduled, returning to the highest priority level to allow priority handling of late arriving priority data.

17. A computer readable medium for causing a computer to execute a method, the method comprising:
selecting a queue based on its priority level and a state of the queue;
when the selected queue has data, scheduling transmission of a packet of data for the selected queue; and
when a packet is scheduled for the selected queue, determining whether higher priority queues have data before scheduling additional transmissions.

18. The computer readable medium of claim 17, wherein selecting a queue comprises:
selecting a queue with the highest priority level;
determining whether there is data in the selected queue;
when there is no data in the selected queue, moving to another queue; and
when there are no additional queues at the priority level, moving to the next priority level.

19. The computer readable medium of claim 17, and further comprising:
when a packet of data is scheduled for the selected queue, determining whether a usage limit has been exceeded for the selected queue;
when the usage limit is exceeded, removing the selected queue from further consideration for scheduling transmissions.

20. The computer readable medium of claim 17, wherein determining whether higher priority queues have data comprises:
returning to the highest priority level; and
checking active queues at each priority level until reaching a queue with data.

21. A downstream scheduler for a cable modem termination system, the downstream scheduler including:
a classifier, adapted to receive incoming packets, and adapted to determine a traffic flow associated with the received packets;
a traffic policer, responsive to the classifier, the traffic policer adapted to monitor each flow for compliance with selected data rates and adapted to store the data packets in associated queues; and
a transmission scheduler, the transmission scheduler including a computer readable medium for performing a method comprising:
selecting a queue based on its priority level and a state of the queue,
when the selected queue has data, scheduling transmission of a packet of data for the selected queue, and
when a packet is scheduled for the selected queue, determining whether higher priority queues have data before scheduling additional transmissions.

22. The downstream scheduler of claim 21, wherein selecting a queue comprises:
selecting a queue with the highest priority level;
determining whether there is data in the selected queue;
when there is no data in the selected queue, moving to another queue; and
when there are no additional queues at the priority level, moving to the next priority level.

23. The downstream scheduler of claim 21, and further comprising:
when a packet of data is scheduled for the selected queue, determining whether a usage limit has been exceeded for the selected queue;
when the usage limit is exceeded, removing the selected queue from further consideration for scheduling transmissions.

24. The downstream scheduler of claim 21, wherein determining whether higher priority queues have data comprises:
returning to the highest priority level; and
checking active queues at each priority level until reaching a queue with data.

25. A computer readable medium for causing a computer to execute a method, the method comprising:
selecting a highest priority level;
selecting a queue in the highest priority level;
determining whether there is data in the selected queue;
when there is no data in the selected queue, moving to the next queue;
when there are no additional queues at the priority level, moving to the next priority level;
when there is data in a selected queue, scheduling transmission of a packet of data;
when a packet is scheduled, determining whether a usage limit has been exceeded;
when the usage limit is exceeded, removing the queue from further consideration for scheduling transmissions; and
when a packet is scheduled, returning to the highest priority level to allow priority handling of late arriving priority data.
